(19) United States
(12) Patent Application Publication
(10) Pub. No.: US 2026/0298120 A1
(43) Pub. Date: Oct. 1, 2026

(54) SYSTEMS, METHODS, AND APPARATUSES FOR ADSORBING CARBON FROM ENGINE EXHAUST GASES

(71) Applicant: CO2 Filter, LLC, Ave Maria, FL (US)

(72) Inventor: Ted H. Thieman, Ave Maria, FL (US)

(73) Assignee: CO2 Filter, LLC, Ave Maria, FL (US)

(21) Appl. No.: 19/634,452

(22) Filed: Mar. 31, 2026

Related U.S. Application Data
(60) Provisional application No. 63/781,066, filed on Mar. 31, 2025.

(51) Int. Cl. F01N 3/08; B01J 20/04

(52) U.S. Cl. CPC F01N 3/0828; B01J 20/041; F01N 2450/30; F01N 2570/10

(57) ABSTRACT

In one aspect, an apparatus for adsorbing carbon from engine exhaust gases is provided.

### CROSS-REFERENCE TO RELATED APPLICATIONS

This application claims priority from U.S. Provisional Patent Application No. 63/781,066 filed on Mar. 31, 2025, which is incorporated by reference herein in its entirety.

### BACKGROUND

Carbon black is a fine, black powder made of nearly pure elemental carbon, produced by the incomplete combustion of hydrocarbons. The process typically involves burning hydrocarbon materials in a limited supply of air or in the absence of oxygen. The resulting soot is processed to create the fine, black powder. Carbon black may be used as a pigment, a reinforcing agent, and a UV stabilizer in various applications like tires, plastics, and inks.

Calcium carbonate (CaCO₂), often mined from limestone or marble deposits, is a versatile mineral used in various industries after being crushed, sieved, and sometimes processed further. Calcium carbonate is used in a wide range of industries, including paper, paint, plastics, rubber, and pharmaceuticals, and may be used to remove contaminants such as iron, magnesium, and silica/silicates.

Calcium carbonate decomposes when heated above a certain temperature (around 840° C.). This decomposition reaction is represented as:

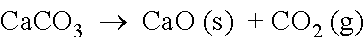

The solid calcium carbonate breaks down into solid calcium oxide (also known as quicklime or burnt lime) and gaseous carbon dioxide. Calcium oxide (CaO) reacts vigorously with water (H₂O) and forms calcium hydroxide Ca(OH)₂. The reaction is represented as:

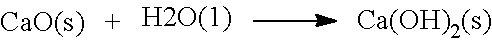

At least the outer surface of calcium hydroxide Ca(OH)₂ is reactive and has been used to purify exhaust gases by reacting with the noxious acidic substances contained in the exhaust gases. See U.S. Pat. No. 5,618,508A, which is incorporated by reference herein in its entirety. However, what remains needed are systems, methods, and apparatuses for adsorbing substantial amounts of carbon from engine exhaust gases, potentially for use in downstream applications.

### SUMMARY

In one aspect, an apparatus for adsorbing carbon from engine exhaust gases is provided, the apparatus comprising: a housing having an interior; an inlet in fluid communication with the interior; an outlet in fluid communication with the interior; and an adsorbing media cartridge positioned within the housing, wherein the adsorbing media cartridge contains an adsorbing media comprising calcium hydroxide.

In another aspect, an apparatus for adsorbing carbon from engine exhaust gases is provided, the apparatus comprising: a housing having an interior; an inlet in fluid communication with the interior; an outlet in fluid communication with the interior; and an adsorbing media package positioned within the housing, wherein the adsorbing media package contains an adsorbing media comprising calcium hydroxide.

In another aspect, a method is provided, the method comprising: providing calcium carbonate; heating the calcium carbonate sufficient to convert it to calcium oxide; contacting the calcium oxide with water while the temperature of the calcium oxide is sufficiently high, to form calcium hydroxide; and confining the calcium hydroxide within an adsorbing media package or cartridge. In some aspects, the adsorbing media package or cartridge may be placed within an apparatus comprising: a housing having an interior; an inlet in fluid communication with the interior; and an outlet in fluid communication with the interior.

### BRIEF DESCRIPTION OF THE FIGURES

The accompanying figures, which are incorporated in and constitute a part of the specification, illustrate various example embodiments, and are used merely to illustrate various example embodiments. In the figures, like elements bear like reference numerals.

FIG. 1A illustrates a perspective view of an apparatus 100 for adsorbing carbon from engine exhaust gases with a cover 104 in place.

FIG. 1B illustrates a perspective view of apparatus 100 for adsorbing carbon from engine exhaust gases with cover 104 removed.

FIG. 1C illustrates a perspective view of apparatus 100 for adsorbing carbon from engine exhaust gases including a plurality of adsorbing media cartridges 114.

FIG. 1D illustrates an elevation view of apparatus 100 for adsorbing carbon from engine exhaust gases including a plurality of adsorbing media cartridges 114.

FIG. 1E illustrates a perspective view of apparatus 100 for adsorbing carbon from engine exhaust gases with an adsorbing media cartridge 114 removed.

FIG. 1F illustrates a perspective view of apparatus 100 for adsorbing carbon from engine exhaust gases with an adsorbing media cartridge 114 removed.

FIG. 1G illustrates a perspective view of apparatus 100 for adsorbing carbon from engine exhaust gases with an adsorbing media cartridge 114 removed.

FIG. 1H illustrates a perspective view of apparatus 100 for adsorbing carbon from engine exhaust gases with an adsorbing media cartridge 114 removed.

FIG. 2A illustrates a perspective view of an apparatus 200 for adsorbing carbon from engine exhaust gases including a plurality of adsorbing media packages 230.

FIG. 2B illustrates a perspective view of apparatus 200 for adsorbing carbon from engine exhaust gases with an adsorbing media package 230 removed.

FIG. 3A illustrates a perspective view of an apparatus 300 for adsorbing carbon from engine exhaust gases including a plurality of adsorbing media packages 230.

FIG. 3B illustrates an elevation view of apparatus 300 for adsorbing carbon from engine exhaust gases including a plurality of adsorbing media packages 230.

FIG. 3C illustrates a perspective view of apparatus 300 for adsorbing carbon from engine exhaust gases with an adsorbing media package 230 removed.

FIG. 3D illustrates a perspective view of apparatus 300 for adsorbing carbon from engine exhaust gases including a plurality of adsorbing media cartridges 114 with an adsorbing media cartridge 114 removed.

FIG. 3E illustrates a perspective view of apparatus 300 for adsorbing carbon from engine exhaust gases with an adsorbing media cartridge 114 removed.

FIG. 4 illustrates adsorbing media 440 including a plurality of media elements 442.

### DETAILED DESCRIPTION

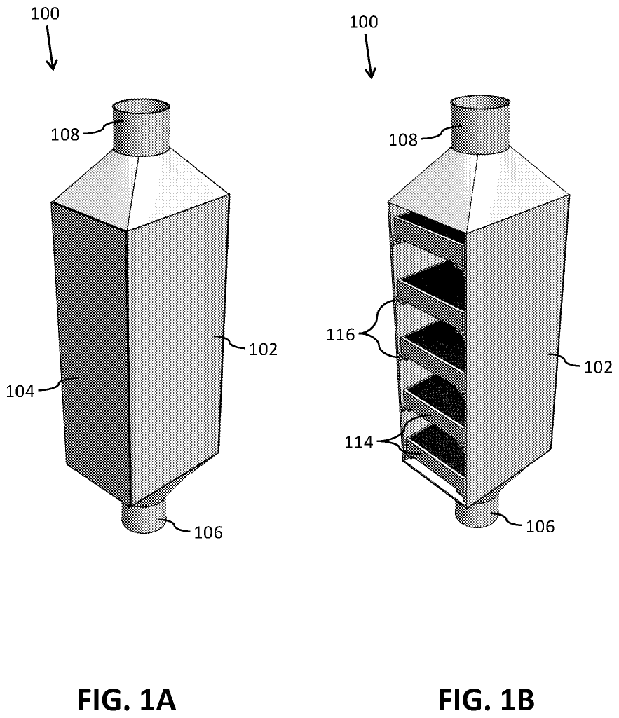

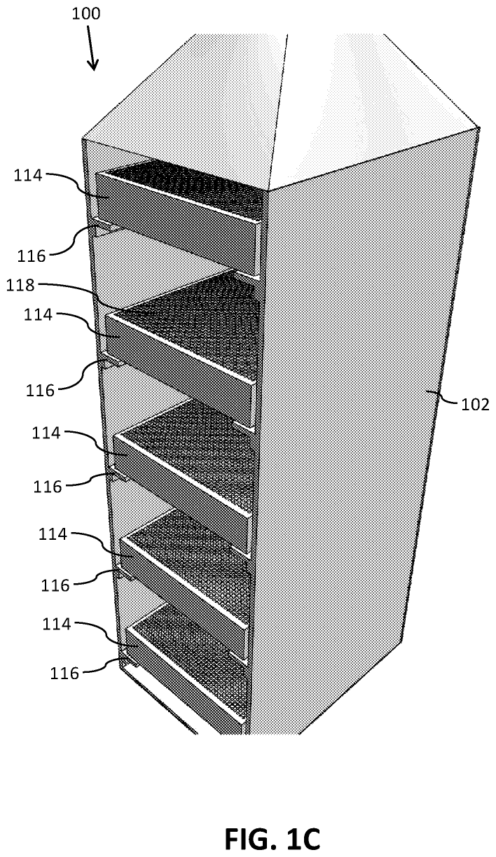

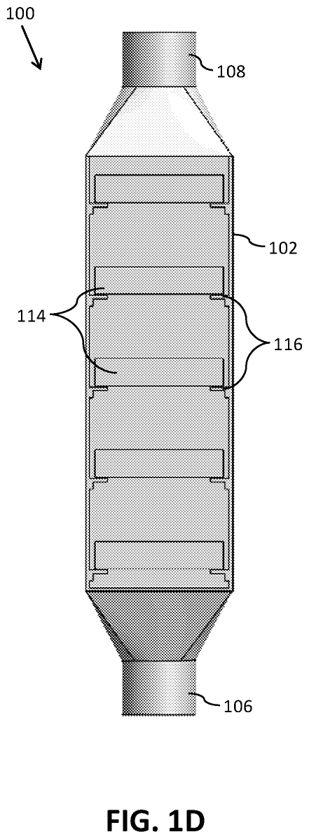

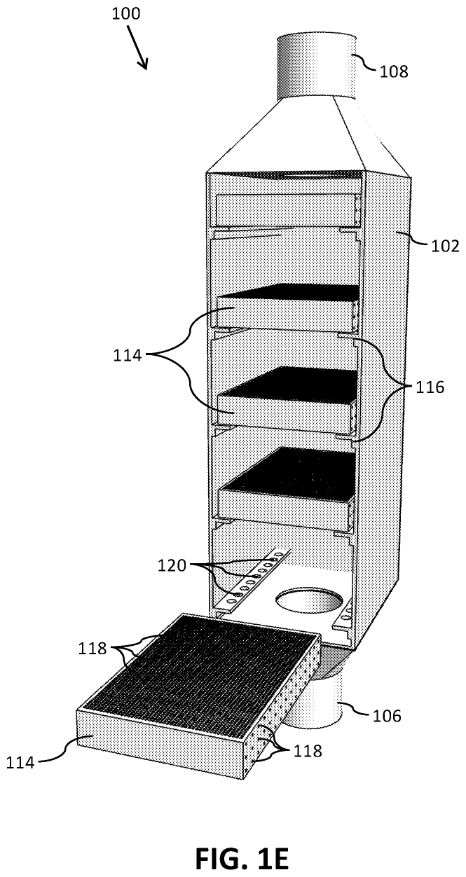

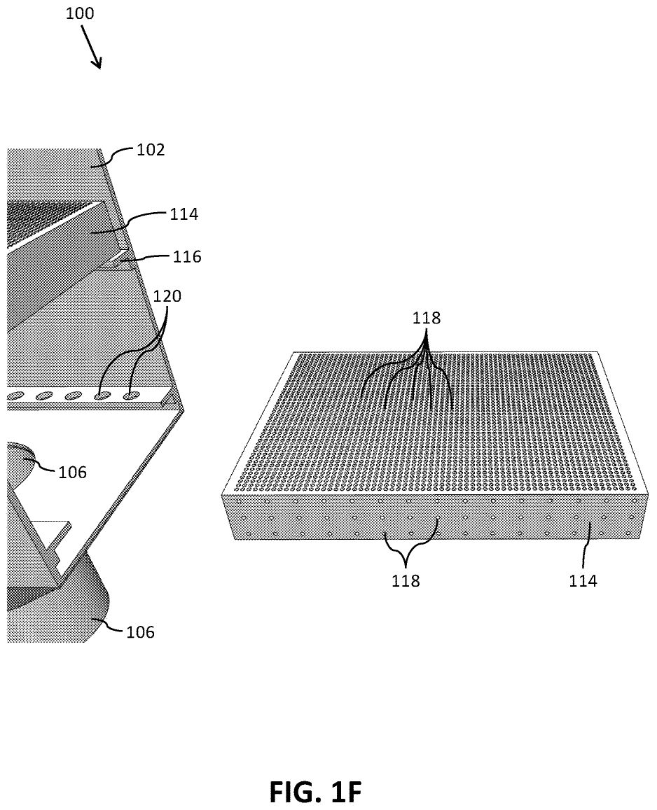

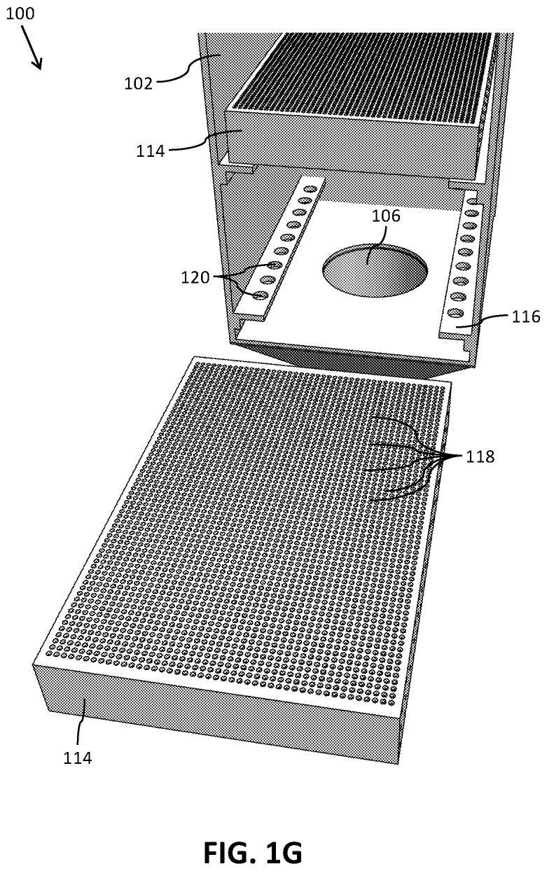

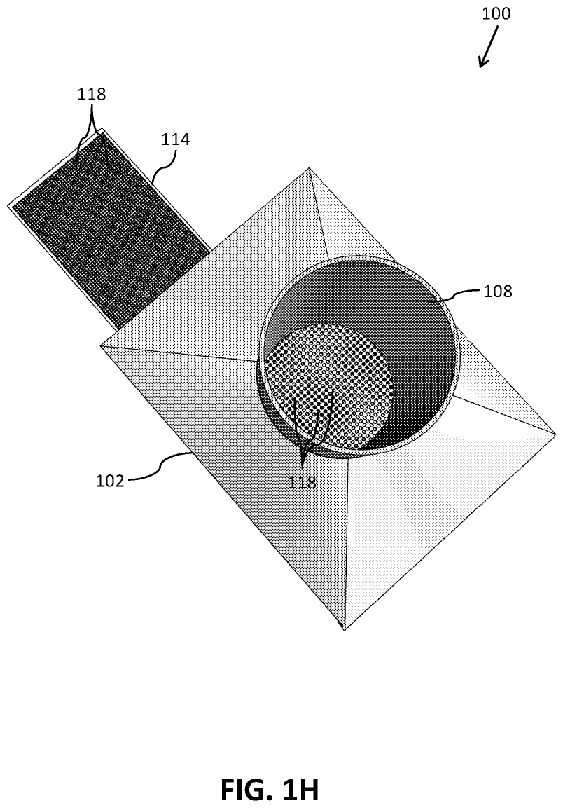

FIGS. 1A-1H illustrate an apparatus 100 for adsorbing carbon from engine exhaust gases. Apparatus 100 includes a housing 102 having a removable cover 104 configured to selectively seal the housing interior and provide access to the interior of housing 102. Apparatus 100, including housing 102 and cover 104, may be made from any of a variety of materials capable of handling the heat of engine exhaust gases (e.g., 200 degrees F. (93 C) or more), including for example, metals, polymers, alloys, composites, and the like. Housing 102 includes an inlet 106 and an outlet 108, both of which are in fluid communication with the interior of housing 102 and configured to permit the entry and exit of engine exhaust gases. Housing 102, cover 104, inlet 106, and outlet 108 may be formed from sheet metal.

Apparatus 100 may be placed in-line downstream from an engine's exhaust outlet. Stated differently, apparatus 100 may be placed in-line within the engine's exhaust system so that engine exhaust gases pass through apparatus 100. Inlet 106 is configured to take in engine exhaust gases, which flow through the interior of housing 102 and exit from outlet 108. Inlet 106 and outlet 108 are sized and shaped to fit an exhaust pipe used in the engine's exhaust system.

Apparatus 100 includes at least one adsorbing media cartridge 114. Adsorbing media cartridge 114 may be formed in any of a variety of shapes, including a cuboid. Adsorbing media cartridge 114 includes a hollow interior and a plurality of apertures 118 permitting engine exhaust gases to pass from the outside of adsorbing media cartridge 114 to the inside of adsorbing media cartridge 114, through a mass of adsorbing media, and back out of adsorbing media cartridge 114. Carbon and/or other pollutants from the engine exhaust gases are adsorbed by the adsorbing media, thereby removing a significant portion of the carbon and/or other pollutants from the exhaust gas. Adsorbing media cartridge 114 may be made out of any of a variety of materials capable of handling the heat of engine exhaust gases (e.g., 200 degrees F. (93 C) or more), including for example, metals, polymers, alloys, composites, and the like.

In the aspect illustrated in FIGS. 1A-1H, exhaust gases flow through the thickness of adsorbing media cartridge 114 along its short axis. Apertures 118 may be arranged on two, four, or all sides of adsorbing media cartridge 114. At least one mounting bracket 116 may be fixed to an interior surface of housing 102 to selectively retain the one or more adsorbing media cartridge 114 within housing 102. In one example aspect, apparatus 100 includes up to five adsorbing media cartridges 114, with mounting brackets 116 corresponding to each adsorbing media cartridge 114.

Mounting brackets 116 include perforations 120 permitting the passage of engine exhaust gases around the sides of adsorbing media cartridge 114, between adsorbing media cartridge 114 and an interior wall of housing 102. Apparatus 100 may be designed to permit the passage of engine exhaust gases through the interior of housing 102 without significant restriction, including after complete coverage of adsorption media, so as to prevent back pressure upon the engine. Perforations 120 may provide an alternate pathway for engine exhaust gases to ensure that there is not significant flow restriction within apparatus 100.

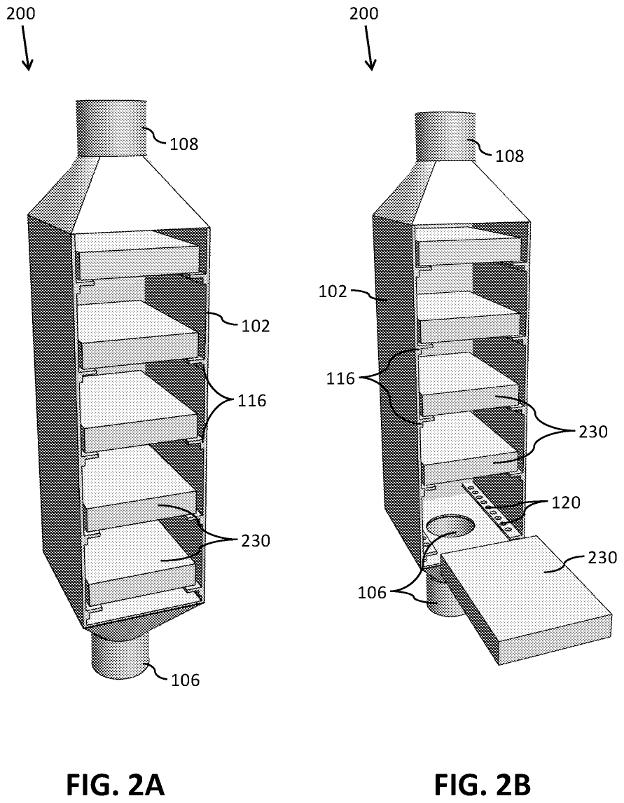

FIGS. 2A-2B illustrate an apparatus 200 for adsorbing carbon from engine exhaust gases including a plurality of adsorbing media packages 230. Apparatus 200 includes the housing 102, inlet 106, inlet 108, mounting brackets 116, and perforations 120 described above with respect to apparatus 100. However, in the place of adsorbing media cartridge 114, apparatus 200 includes adsorbing media packages 230. Adsorbing media packages 230 may be less rigid than adsorbing media cartridge 114, and may be made out of any of a variety of materials capable of handling the heat of engine exhaust gases (e.g., 200 degrees F. (93 C) or more), including for example, textiles, metals, polymers, alloys, composites, and the like. Adsorbing media packages 230 may be made from a fabric, a textile mesh, a wire mesh, a netting, or the like, and contain a mass of adsorbing media. Adsorbing media package 230 may be a cloth bag that contains a mass of adsorbing media.

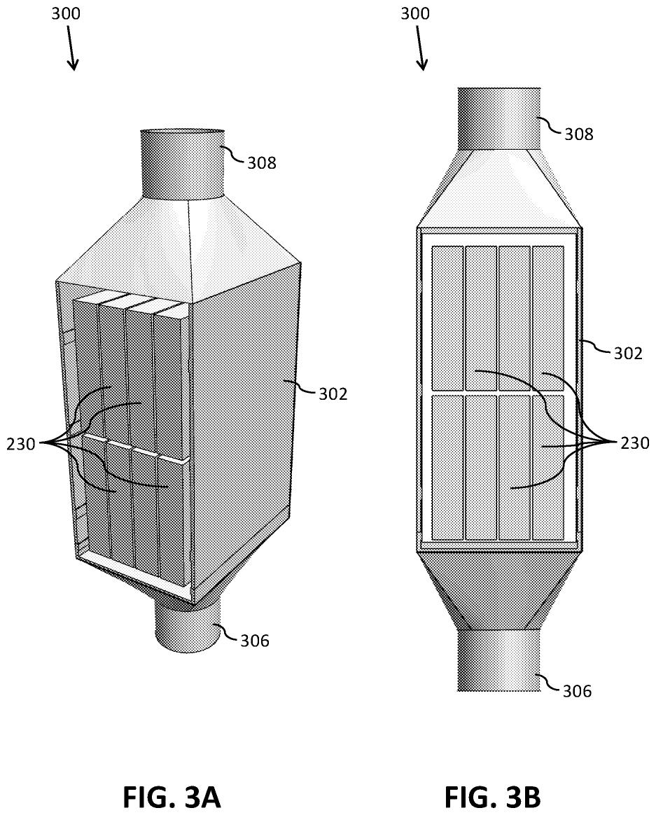

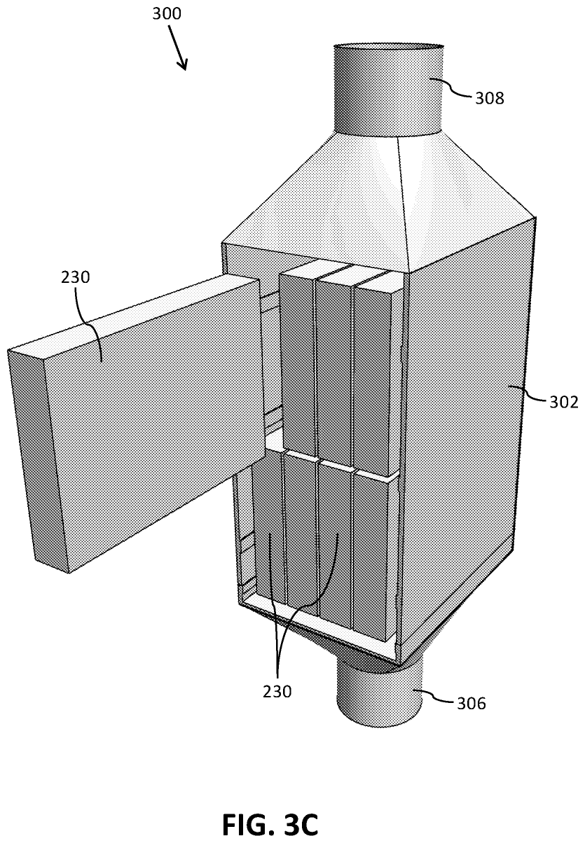

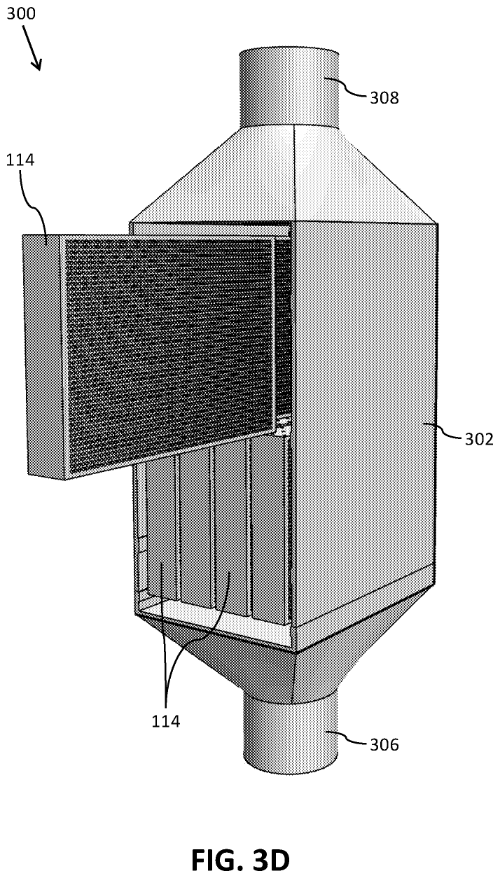

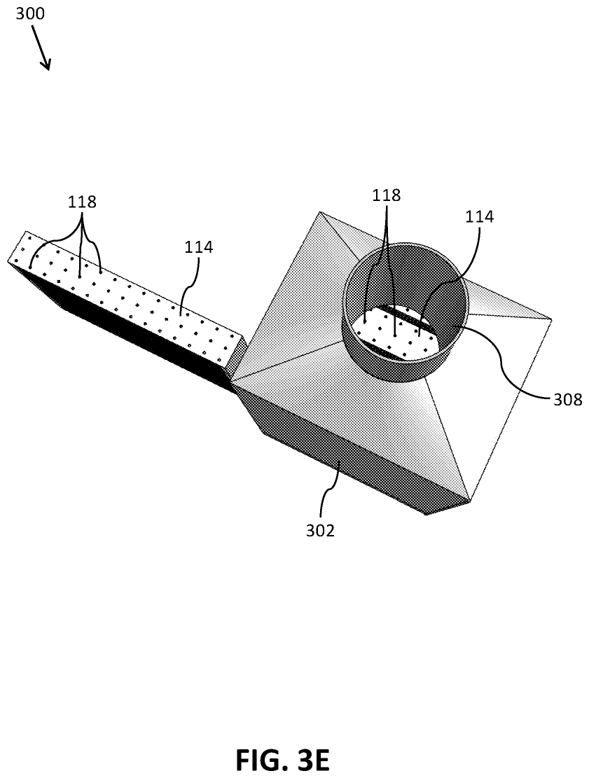

FIGS. 3A-3E illustrate an apparatus 300 for adsorbing carbon from engine exhaust gases including a plurality of adsorbing media packages 230. Apparatus 300 includes a housing 302 with a cover (not shown), an inlet 306, and an outlet 308. Housing 302, the cover, inlet 306, and outlet 308 may be substantially similar to housing 102, cover 104, inlet 106, and outlet 108 described above with respect to apparatus 100, 200, except where noted herein.

FIGS. 3A-3C illustrate an aspect wherein apparatus 300 includes an array of adsorbing media packages 230 arranged in a grid pattern, wherein adsorbing media packages 230 are oriented to receive a flow of engine exhaust gases along a long axis of adsorbing media packages 230. Adsorbing media packages 230 are positioned such that a gap exists between adsorbing media packages 230 and an interior of housing 302 so that significant constriction of the exhaust gases is prevented. In one example aspect, apparatus 300 may include up to eight adsorbing media packages 230 arranged in a grid pattern.

FIGS. 3D-3E illustrate an aspect wherein apparatus 300 includes an array of adsorbing media cartridges 114 arranged in a grid pattern, wherein adsorbing media cartridges 114 are oriented to receive a flow of engine exhaust gases along a long axis of adsorbing media cartridges 114. Adsorbing media cartridges 114 are positioned such that a gap exists between adsorbing media cartridges 114 and an interior of housing 302 such that significant constriction of the exhaust gases is avoided. In one example aspect, apparatus 300 may include up to eight adsorbing media cartridges 114 arranged in a grid pattern.

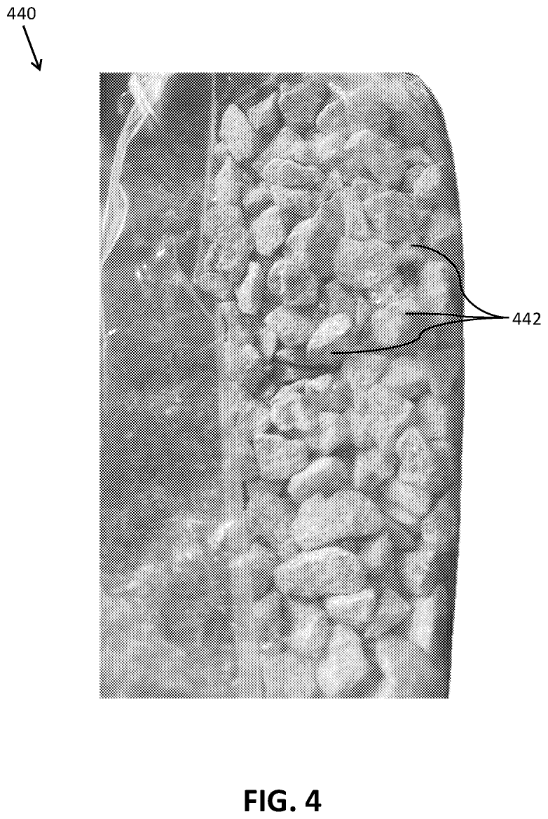

FIG. 4 illustrates adsorbing media 440 including a plurality of media elements 442. Adsorbing media 440 may comprise a calcium hydroxide material, e.g., Ca(OH)₂. Adsorbing media 440 may include about 50% by volume of the interior of adsorbing media cartridges 114 or adsorbing media packages 230 so that engine exhaust gases may flow through adsorbing media 440 with minimal flow restriction. Media elements 442 may be irregular in shape. Media elements 442 may have average maximum dimensions between about 0.125 in. (3.175 mm) and about 0.1875 in. (4.7625 mm).

In use, a driver, operator, mechanic, technician, or other personnel responsible for maintaining an engine or vehicle may access the interior of apparatus 100, 200, 300, where apparatus 100, 200, 300 is plumbed into the engine's exhaust system, by removing a cover, such as cover 104. The individual may remove spent adsorbing media cartridges 114 or adsorbing media packages 230, and replace them with fresh adsorbing media cartridges 114 or adsorbing media packages 230. This maintenance may be necessary on any of a variety of schedules depending upon the mass of adsorbing media, the hours of operation of the engine in an intervening period, the use of other emissions/pollutant removal systems, and the like. In one aspect, this maintenance may be necessary approximately once a week in a commercial vehicle operated consistently throughout the week, and may be completed during a refueling operation.

In one possible aspect, apparatus 100, 200, 300 is used on a vehicle such as a commercial truck. Apparatus 100, 200, 300 may be positioned on, beneath, or behind the running board of the truck. Alternatively, apparatus 100, 200, 300 may be positioned on the rear of the cab of the truck. Alternatively, apparatus 100, 200, 300 may be positioned on the one or more exhaust stack of the truck.

### EXAMPLE

Calcium carbonate (CaCO₂) was obtained from Sherwood Mining Co. (Sherwood, TN, USA). The CaCO₂ was ground to a size that stayed on a 6-mesh sieve (average maximum dimensions between about 0.125 in. (3.175 mm) and about 0.1875 in. (4.7625 mm). The ground CaCO₂ was placed in a furnace, heated to 1650° F., and quenched with water. The resultant calcium hydroxide product was placed inside of a cloth bag, and the cloth bag was placed within an apparatus as described herein. The apparatus was placed in-line with an engine's exhaust system so that engine's exhaust gases passed through the apparatus for a specified period to permit carbon from the gases to adsorb to the calcium hydroxide product. Table 1 shows the total carbon content by LECO or ASTM C 25 elemental analysis of the carbon-adsorbed calcium hydroxide product for several independent runs.

| Engine Type | Carbon Content (%) |
|---|---|
| Detroit Diesel Series 60 engine (high velocity) | 11.7 |
| Detroit Diesel Series 60 engine (high velocity) | 11.9 |
| Detroit Diesel Series 60 engine (low velocity) | 11.7 |
| Automobile (2000 miles) | 11.9 |
| Detroit Diesel Series 60 engine (high velocity) | 11.9 |
| Detroit Diesel Series 60 engine (high velocity) | 12.0 |
| Detroit Diesel Series 60 engine (high velocity) | 11.4 |

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. An apparatus for adsorbing carbon from engine exhaust gases, comprising:
a housing having an interior;
an inlet in fluid communication with the interior;
an outlet in fluid communication with the interior; and
an adsorbing media cartridge positioned within the housing, wherein the adsorbing media cartridge contains an adsorbing media.

2. The apparatus of claim 1, wherein the adsorbing media cartridge includes a plurality of apertures extending from an outside of the adsorbing media cartridge to an inside of the adsorbing media cartridge.

3. The apparatus of claim 1, wherein the adsorbing media is calcium hydroxide.

4. The apparatus of claim 1, wherein the adsorbing media comprises a plurality of media elements, and wherein the media elements are irregular in shape.

5. The apparatus of claim 1, wherein the adsorbing media comprises a plurality of media elements, and wherein the media elements have average maximum dimensions between 0.125 in. and 0.1875 in.

6. The apparatus of claim 1, wherein the adsorbing media is 50% by volume of an interior of the adsorbing media cartridge.

7. The apparatus of claim 1, further comprising at least one mounting bracket fixed to an interior surface of the housing, wherein the at least one mounting bracket selectively retains the adsorbing media cartridge.

8. The apparatus of claim 7, wherein the at least one mounting bracket includes perforations.

9. The apparatus of claim 1, wherein the housing includes a removable cover sealing the interior.

10. The apparatus of claim 1, wherein the apparatus is plumbed to an engine's exhaust system, such that engine exhaust gases pass into the housing through the inlet and out of the housing through the outlet.

11. An apparatus for adsorbing carbon from engine exhaust gases, comprising:
a housing having an interior;
an inlet in fluid communication with the interior;
an outlet in fluid communication with the interior; and
an adsorbing media package positioned within the housing, wherein the adsorbing media package contains an adsorbing media.

12. The apparatus of claim 11, wherein the adsorbing media package includes a textile mesh material having openings extending from an outside of the adsorbing media package to an inside of the adsorbing media package.

13. The apparatus of claim 11, wherein the adsorbing media package includes a cloth bag having openings extending from an outside of the adsorbing media package to an inside of the adsorbing media package.

14. The apparatus of claim 11, wherein the adsorbing media is calcium hydroxide.

15. The apparatus of claim 11, wherein the adsorbing media comprises a plurality of media elements, and wherein the media elements are irregular in shape.

16. The apparatus of claim 11, wherein the adsorbing media is 50% by volume of an interior of the adsorbing media package.

17. The apparatus of claim 11, further comprising at least one mounting bracket fixed to an interior surface of the housing, wherein the at least one mounting bracket selectively retains the adsorbing media package.

18. The apparatus of claim 17, wherein the at least one mounting bracket includes perforations.

19. The apparatus of claim 11, wherein the housing includes a removable cover sealing the interior.

20. The apparatus of claim 11, wherein the apparatus is plumbed to an engine's exhaust system, such that engine exhaust gases pass into the housing through the inlet and out of the housing through the outlet.
